(19) United States
(12) Patent Application Publication
(10) Pub. No.: US 2026/0141254 A1
(43) Pub. Date: May 21, 2026

(54) CLOSED-LOOP SUPERVISED FINE-TUNING OF TOKENIZED TRAFFIC MODELS

(71) Applicant: NVIDIA Corporation, Santa Clara, CA (US)

(72) Inventors: Zhejun Zhang, Zurich (CH); Peter Karkus, Zurich (CH); Maximilian Igl, Zurich (CH); Wenhao Ding, San Jose, CA (US); Yuxiao Chen, Campbell, CA (US); Boris Ivanovic, Mountain View, CA (US); Marco Pavone, Stanford, CA (US)

(21) Appl. No.: 19/336,295

(22) Filed: Sep. 22, 2025

Related U.S. Application Data
(60) Provisional application No. 63/723,497, filed on Nov. 21, 2024.

(51) Int. Cl. G06N 3/092; G06N 3/042

(52) U.S. Cl. CPC G06N 3/092; G06N 3/042

(57) ABSTRACT

Imitation learning, or artificial intelligence-based learning from demonstration, aims to acquire an agent policy by observing and mimicking the behavior demonstrated in expert demonstrations. Imitation learning can be used to generate reliable and robust learned policies in a variety of tasks involving sequential decision-making, such as autonomous driving and robotics tasks. However, existing methods that use next-token-prediction (NTP) models, where the policy reduces to a classifier over a discrete set of trajectory tokens, suffer from covariate shift due to their open-loop training a closed-loop execution. The present disclosure provides closed-loop fine tuning of autonomous agent policies in a manner that can mitigate covariate shift.

### CLAIM OF PRIORITY

This application claims the benefit of U.S. Provisional Application No. 63/723,497 (Attorney Docket No. NVIDP1426+/24-ZU-1611US01) titled “CLOSED-LOOP SUPERVISED FINE-TUNING OF TOKENIZED TRAFFIC MODELS,” filed Nov. 21, 2024, the entire contents of which is incorporated herein by reference.

### TECHNICAL FIELD

The present disclosure relates to learning policies for autonomous agents.

### BACKGROUND

Imitation learning, or artificial intelligence-based learning from demonstration, aims to acquire an agent policy by observing and mimicking the behavior demonstrated in expert demonstrations. Various imitation learning methods have enabled deploying reliable and robust learned policies in a variety of tasks involving sequential decision-making, especially in the scenarios where devising a reward function is intricate or uncertain, or when learning in a trial-and-error manner is expensive or unsafe.

For example, traffic modeling is a cornerstone of autonomous driving simulation and evaluation, typically formulated as learning a multi-agent policy that imitates the behavior of traffic participants in the real world. Given a set of historical agent trajectories and scene context (map, traffic light states, etc.), the policy generates actions for all simulated agents. The task gives rise to an imitation learning problem, with two key challenges: multimodality and covariate shift. However, traffic agent behavior is highly multimodal, and faithfully recovering accurate behavior distributions is a key challenge in the field.

Inspired by large language models, recent works introduce next-token-prediction (NTP) models where the policy reduces to a classifier over a discrete set of trajectory tokens, which makes it easier to represent highly-multimodal distributions. However, these models are typically trained through open-loop behavior cloning, and thus suffer from covariate shift when executed in closed-loop during simulation. More specifically, the covariate shift occurs when the model is trained on a fixed dataset of expert demonstrations but faces a distribution mismatch between the states seen during training and those encountered during deployment such that small errors compound and lead to unseen states where the policy performs poorly.

There is a need for addressing these issues and/or other issues associated with the prior art. For example, there is a need to provide closed-loop fine tuning of autonomous agent policies, such as traffic models, in a manner that can mitigate covariate shift.

### SUMMARY

A method, computer readable medium, and system are disclosed for refining a policy for an autonomous agent. A plurality of steps of a policy for an autonomous agent are rolled out to generate a sequence of alternating states and actions, including at each step of the plurality of steps: processing a current state by the policy to generate a plurality of candidate actions, and selecting a target action from the plurality of candidate actions that results in a next state that most closely aligns with an expert demonstration. The policy is refined based on the sequence of alternating states and actions.

### BRIEF DESCRIPTION OF THE DRAWINGS

FIG. 1 illustrates a flowchart of a method for refining a policy for an autonomous agent, in accordance with an embodiment.

FIG. 2 illustrates a system pipeline for refining a policy for an autonomous agent, in accordance with an embodiment.

FIGS. 3A-B illustrate exemplary rollout results generated by the system pipeline in FIG. 2, in accordance with an embodiment.

FIG. 4 illustrates a flowchart of a method for using a policy trained to imitate expert behaviors, in accordance with an embodiment.

FIG. 5A illustrates inference and/or training logic, according to at least one embodiment;

FIG. 5B illustrates inference and/or training logic, according to at least one embodiment;

FIG. 6 illustrates training and deployment of a neural network, according to at least one embodiment;

FIG. 7 illustrates an example data center system, according to at least one embodiment.

### DETAILED DESCRIPTION

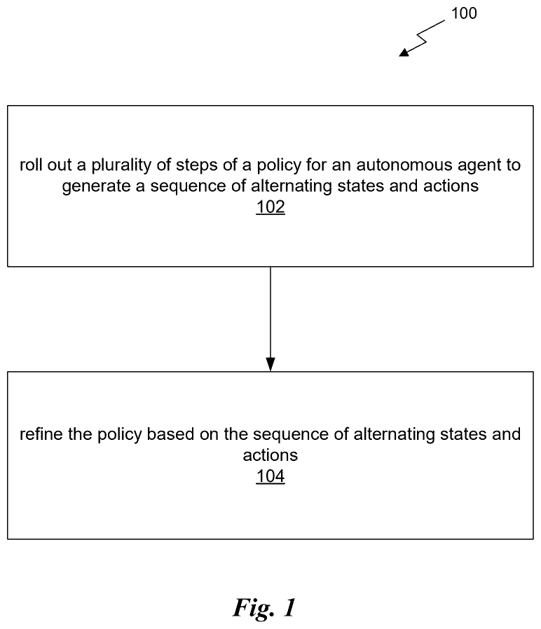

FIG. 1 illustrates a flowchart of a method 100 for refining a policy for an autonomous agent, in accordance with an embodiment. The method 100 may be performed by a device, which may be comprised of a processing unit, a program, custom circuitry, or a combination thereof, in an embodiment. In another embodiment, a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

As mentioned above, the method 100 is performed for refining (i.e. fine-tuning) a policy for an autonomous agent. Accordingly, the method 100 is performed on a policy that has been pretrained. The policy refers to a set of rules or strategies that defines the decision-making process of an autonomous agent to achieve an objective. Given an input state, the policy is configured to generate the action to be taken by the autonomous agent. The autonomous agent may be an autonomous driving vehicle, a robot, or any other machine configured to operate autonomously using the policy.

In an embodiment, the policy may be pretrained to imitate expert behaviors. In an embodiment, the expert behaviors may be considered the ground truth for the policy. For example, the policy may be pretrained using behavior cloning (BC). Expert behaviors refer to the actions taken by an expert at various states, which in combination represent an optimal or targeted decision-making process to achieve the objective. In the context of the present description, the expert behaviors are included in at least one expert demonstration. In an embodiment, the at least one expert demonstration includes a recording of an expert performing a task (i.e. to achieve the objective). In an embodiment, the at least one expert demonstration is represented by expert data that includes a set of data points. Each data point in the set of data points may consist of expert state-action pairs, with each such pair including a state and an action taken by the expert in the state.

Further, the policy may be pretrained for a single task. In this embodiment, the expert behaviors that the policy is trained to imitate may demonstrate the single task. In another embodiment, the policy may be trained for a plurality of different tasks. In this embodiment, the expert behaviors that the policy is trained to imitate may demonstrate the plurality of different tasks. The task(s) may be at least one robotics task (e.g. gripping, pushing, moving, etc. of objects), at least one autonomous driving task (e.g. accelerating, decelerating, stopping, turning, merging, etc.), etc.

In one embodiment the policy may be trained for at least one robotics task. The robotic task(s) may include gripping, pushing, moving, etc. of objects, for example. In another embodiment, the policy may be trained for at least one autonomous driving task. For example, the autonomous driving task(s) may include accelerating, decelerating, stopping, turning, merging, etc. More specifically, the policy may be a NTP policy trained for a traffic simulation task or a policy parameterized as GMM and trained for an ego-motion planning task.

Returning to the method 100, in operation 102, a plurality of steps of the policy for the autonomous agent are rolled out to generate a sequence of alternating states and actions. In other words, the policy is rolled out over the plurality of steps to result in a sequence of alternating states and actions. In an embodiment, a number of the plurality of steps over which the policy is rolled out may be predefined. In an embodiment, the rolling out may be performed by a simulator.

With respect to the present embodiment, the rolling out includes, at each step of the plurality of steps: processing a current state by the policy to generate a plurality of candidate actions, and selecting a target action from the plurality of candidate actions that results in a next state that most closely aligns with an expert demonstration. In an embodiment, the rolling out may be initiated at an initial (observed) state of an expert demonstration. In other embodiments, the rolling out may be initiated at any predefined state (e.g. of the expert demonstration).

In an embodiment, the plurality of candidate actions that are generated using the policy may include a predefined number of candidate actions. In an embodiment, the plurality of candidate actions may include a predefined number of the most probable (i.e. likeliest) actions for the current state. In an embodiment, the probability of a plurality of actions may be determined according to the policy. In an embodiment, the plurality of candidate actions may be generated using a tokenized transformer.

In an embodiment, selecting the target action from the plurality of candidate actions that results in the next state that most closely aligns with the expert demonstration may include: for each candidate action of the plurality of candidate actions, computing a distance of a next state observed at a next timestep as a result of the candidate action to a state of the expert demonstration at the next timestep, and selecting as the target action, from the plurality of candidate actions, one of the candidate actions with the least distance to the state of the expert demonstration at the next timestep. The state observed at the next timestep as a result of the target action is then used as the current state for the next rolling out step, during which the processing of this current state and the selecting of a resulting target action is repeated, per the embodiments above.

To this end, at each rolling out step in operation 102, an observed state and its resulting (target) action are determined. From the target action, at a next rolling out step, a new state is observed and a new target action is determined therefrom. In this way, the plurality of rolling out steps generate a sequence of alternating states and actions that closely align with the expert demonstration.

In operation 104, the policy is refined based on the sequence of alternating states and actions. Refining the policy refers to fine-tuning, or further training, the policy. In an embodiment, refining the policy may include training the policy based on a training target. The training target may be to replicate the sequence of alternating states and actions, in an embodiment. In another embodiment, the training target may be proximity to the expert demonstration. In any case, the policy may be refined by updating is parameters based on a loss computed using the training target.

In an embodiment, the rolling out and the refining of the method 100 may be repeated for each of a plurality of expert demonstrations. As noted above, the policy may be pretrained for a single task, and in this case the rolling out and the refining may be performed one or more times using one or more respective expert demonstrations of that single task. In another embodiment where the policy is pretrained on multiple different tasks, then the rolling out and the refining may be performed one or more times for each different task using one or more respective expert demonstrations of the task.

To this end, the method 100, when performed (e.g. by a device), refines the policy for the autonomous agent. In particular, by rolling out a plurality of steps of the policy to generate a sequence of alternating states and actions and then using that sequence of alternating states and actions to refine the policy, closed-loop fine tuning of the policy may be provided. Further, the closed-loop fine tuning process may mitigate the covariate shift otherwise exhibited for agent policies that are trained through open-loop behavior cloning but executed in closed-loop. In the present description, covariate shift refers to small errors that compound over multiple execution steps to eventually lead to unseen states where the policy performs poorly.

Furthermore, in an embodiment, the method 100 may include deploying the refined policy. Deploying the refined policy refers to integrating (e.g. installing, storing, etc.) the policy in an execution environment. In embodiments, the execution environment may be the device performing the method 100 or another device (e.g. computer system) with resources (e.g. processors, etc.) configured to execute the policy.

In an embodiment, the execution environment may be a simulation environment. For example, as mentioned above, the policy may be pretrained and finetuned per the method 100 for a traffic simulation task. In this embodiment, the policy may be executed to simulate vehicle traffic scenarios. In another embodiment, the execution environment may be a real-world environment. For example, as mentioned above, the policy may be pretrained and finetuned per the method 100 for an ego-motion planning task. In this embodiment, the policy may be executed to provide motion planning for, and in turn control of, an autonomous agent, such as an autonomous vehicle or autonomous robot.

### Exemplary Implementation of the Method 100 for an Autonomous Driving Policy

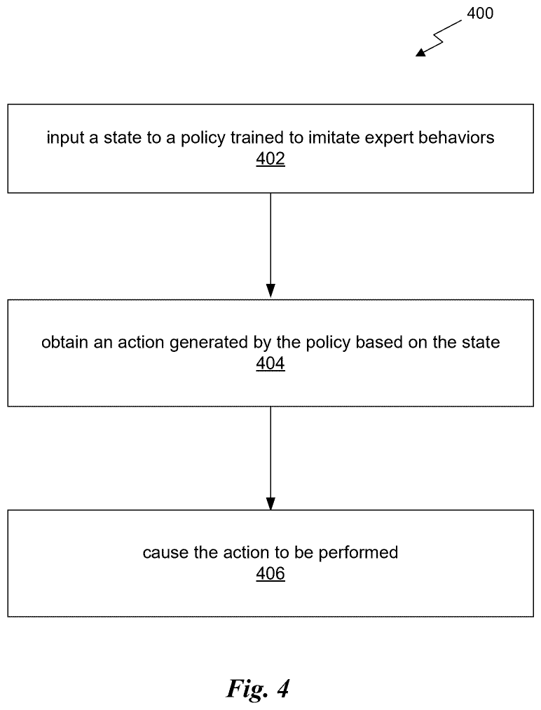

As noted above, in an embodiment, the method 100 may be carried out to refine a policy for an autonomous vehicle. In this embodiment, the method 100 may be implemented to: access an expert demonstration of an autonomous vehicle navigating an environment; access a pretrained autonomous driving policy; roll out a plurality of steps of the pretrained autonomous driving policy to generate a sequence of alternating autonomous driving states and autonomous driving actions, including at each step of the plurality of steps: processing a current autonomous driving state by the pretrained autonomous driving policy to generate a plurality of candidate autonomous driving actions, and selecting a target autonomous driving action from the plurality of candidate autonomous driving actions that results in a next autonomous driving state that most closely aligns with the expert demonstration; fine-tune the autonomous driving policy using on the sequence of alternating autonomous driving states and autonomous driving actions; and cause a real-world autonomous vehicle to operate in accordance with the fine-tuned autonomous driving policy (e.g. by deploying the fine-tuned autonomous driving policy to an execution environment for use by an autonomous driving application that controls the real-world autonomous vehicle, for example per the method 400 of FIG. 4).

Further embodiments will now be provided in the description of the subsequent figures. It should be noted that the embodiments disclosed herein with reference to the method 100 of FIG. 1 may apply to and/or be used in combination with any of the embodiments of the remaining figures below.

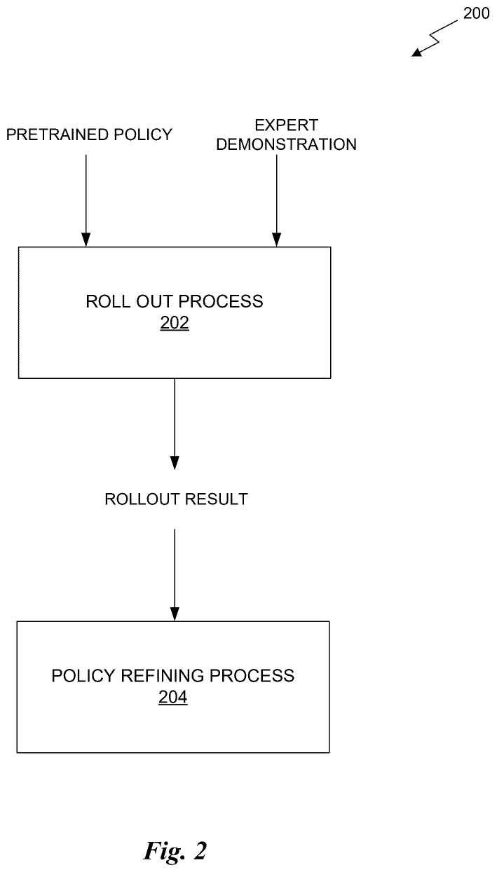

FIG. 2 illustrates a system pipeline 200 for refining a policy for an autonomous agent, in accordance with an embodiment. The system pipeline 200 may be implemented to carry out the method 100 of FIG. 1, in an embodiment. Accordingly, the definitions and descriptions provided above may equally apply to the present embodiment.

As shown, the system pipeline 200 includes a rollout process 202 and a policy refining process 204. The rollout process 202 and the policy refining process 204 may be implemented in hardware and/or software of one or more computer systems.

The rollout process 202 is configured to take a pretrained policy for an autonomous agent and an expert demonstration as input and to rollout a plurality of steps of the policy guided by the expert demonstration to generate a sequence of alternating states and actions. At each step of the plurality of steps, the rollout process 202 is configured to process a current state by the policy to generate a plurality of candidate actions, and select a target action from the plurality of candidate actions that results in a next state that most closely aligns with the expert demonstration.

The policy refining process 204 is configured to take the sequence of alternating states and actions generated by the rollout process 202 as input and to refine the policy based on that sequence. A training target may be preconfigured for the policy refining process 204, to constrain the refinement of the policy towards the training target. In an embodiment, the training target may be to replicate the sequence of alternating states and actions. In another embodiment, the training target may be a (e.g. defined degree of) proximity to the expert demonstration.

### Exemplary Implementation of the System Pipeline 200

### Problem Formation

A multi-agent traffic simulation policy can be typically formulated as π_{θ}(aₜ|hₜ, M), where θ denotes the trainable model parameters, hₜ=s_{t-H:t} is the state history of length H, M is the context, including for example high-definition (HD) maps and traffic light states, t is the current time step,

$${a}_{t} = [ {a}_{t}^{1} , … , {a}_{t}^{N} ] and {s}_{t} = [ {s}_{t}^{1} , … , {s}_{t}^{N} ]$$

are respectively the actions and states of N agents at the current time step. The dimensions of actions a and states s are respectively denoted as Dₐ and Dₛ, i.e., α∈ [symbol] ^{D}^{ₐ} and s∈ [symbol] ^{D}^{ₛ}. From the current states and actions at step t, the next states are computed using the per-agent forward dynamics

$${s}_{t + 1} = f ( {s}_{t} , {a}_{t} ) = {[ f ( {s}_{t}^{i} , {a}_{t}^{i} ) ]}_{i = 1}^{N} .$$

It is assumed that

$$f ( {s}_{t}^{i} , {a}_{t}^{i} )$$

is deterministic, and can be queried during training, which is the case for traffic simulation. A rollout of T steps starting at t=0 is defined as a sequence of states s_{0:T}=[s₀, . . . , s_{T}], while the ground truth trajectories of all agents are denoted as ŝ_{0:T} For the training, a dataset

$$D = {\{ {\hat{s}}_{0 : T}^{j} , {M}^{j} \}}_{j = 1}^{\vert D \vert}$$

of such real-world trajectories to be emulated with their corresponding contexts.

### Next Token Prediction (NTP) Policies

NTP policies are parameterized as a probability distribution over a vocabulary of action tokens denoted as V={x_{c}|c=1, 2, . . . , |V|}, where |V| is the size of the vocabulary, x_{c}, ∈ [symbol] ^{D}^{ₐ} are template actions and c∈ [symbol] is the token index. Hence, an autoregressive NTP policy for traffic simulation can equivalently be written as an agent-factorized categorical distribution at each timestep t, as shown in Equation 1.

### Equation 1

$${π}_{θ} = ( {c}_{t} \vert {h}_{t} , M ) = {\prod }_{i = 1}^{N} {π}_{θ} ( {c}_{t}^{i} \vert {h}_{t} , M ) = {\prod }_{i = 1}^{N} C a t ( {c}_{t}^{i} )$$

Where

$$Cat ( {c}_{t}^{i} )$$

is the categorical distribution over the action token index for agent i (and not to be confused with the CAT-K method described in detail below). Given the sampled output

$${c}_{t} = [ {c}_{t}^{1} , … , {c}_{t}^{N} ] ,$$

the actions

$${a}_{t} = [ {x}_{{c}_{t}^{1}} , … , {x}_{{c}_{t}^{N}} ]$$

are obtained using the token vocabulary V.

### Refining a Policy for an Autonomous Agent

Two key challenges in learning a policy from real-world trajectories are the multimodal nature of the trajectory distribution and the problem of covariate shift when policies are trained open-loop, resulting in a distribution mismatch between expert states seen during training and states visited during policy deployment. Covariate shift can be overcome by closed-loop training, i.e., by training on trajectories sampled from the learned policy. However, this requires the generation of expert actions (or other notions of optimality) to be used as training targets along those trajectories. Querying a human expert is infeasible at scale, reinforcement learning (RL)-based methods require hard-to-define rewards, and methods such as Generative Adversarial Imitation Learning (GAIL) are prone to mode collapse.

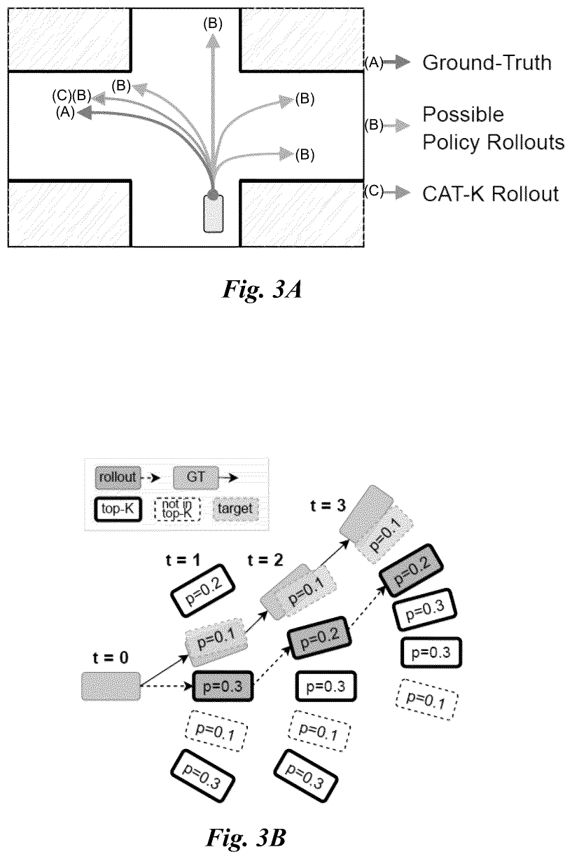

An alternative strategy for generating “expert” actions is to construct recovery actions that bring the agent back to the available ground truth trajectory. However, this is complicated by the multimodal nature of the data, as the available ground truth trajectory might not be a valid recovery target for the generated trajectory. For example, as shown in FIG. 3A, the ground truth trajectory ŝ_{0:T} turns left at the intersection, while the sampled trajectory s_{0:T}˜π_{θ} might go straight or turn right. As a result, while some state-of-the-art traffic models augment the training data with recovery actions to reduce the covariate shift, they do so only from states that were reached by injecting small amounts of noise into the ground truth trajectory. This does guarantee that the ground truth trajectory remains a valid recovery target, but it completely ignores the learned policy and the state distribution induced by it.

Instead, the method presented herein, referred to as Closest Among Top-K (CAT-K) rollout, informs the sampling process by the learned policy, but biases it towards the ground truth trajectory to guarantee the validity of the recovery actions.

### Closest Among Top-K (CAT-K) Rollout

To facilitate the formulation, a top^{K} operator is defined per Equation 2.

$$\{ {ξ}_{1} , … , {ξ}_{K} \} = {top}^{K} ( C a t ( c ) ) , c ∈ \{ 1 , … , \vert V \vert \} \qquad Equation 2$$

Where Cat [symbol] → [symbol] is the probability density of a categorical distribution on the vocabulary index, and {ξ₁ . . . ξ_{K}} are the K most probable indices. The top^{K} operator can be considered as a variation of the arg max operator that returns multiple indices, with top¹ equivalent to argmax.

At time step t, the policy π_{θ}(aₜ|hₜ, M) outputs independent categorical distributions over the token vocabulary for each agent. The method, CAT-K rollout, deterministically rolls out the policy by selecting, at each time step and for each agent, the one action among the top-K likeliest according to π_{θ} that brings the agent closest to the ground truth next state. Using a distance metric d(·, ·) on the states, this is formally expressed per Equations 3 and 4.

$${c}_{t}^{i} = arg min d ( f ( {s}_{t}^{i} , {x}_{c} ) , {\hat{s}}_{t + 1}^{i} , c = \{ {ξ}_{1} , … , {ξ}_{K} \} \qquad Equation 3$$

$$\begin{matrix}\{ {ξ}_{1} , … , {ξ}_{K} \} = {top}^{K} [ π ( {c}_{t}^{i} \vert {h}_{t} , M ) ] \\ {c}_{t}^{i} = \{ 1 , … , \vert V \vert \}\end{matrix} , \qquad Equation 4$$

Where

$${c}_{t}^{i}$$

is the action token indices of agent i at step t for the CAT-K rollout, and {ξ₁, . . . , ξ_{K}} are the top-K likeliest token index according to the policy. Given

$${c}_{t}^{i} ,$$

the next state is obtained using the vocabulary V and the dynamics per Equation 5.

$${s}_{t + 1}^{i} = f ( {s}_{t}^{i} , {x}_{{c}_{t}^{i}} ) \qquad Equation 5$$

These rollout states will be used as the input h to the policy at the next time step. By doing this sequentially from t=0 to t=T−1 and repeating for all N agents, the CAT-K rollout trajectories s_{0:T} are obtained.

### Closed-Loop Supervised Fine-Tuning

Given the CAT-K rollout trajectory s_{0:T}, the recovery action indices ĉₜ are constructed from the ground truth trajectories ŝ_{0:T} by finding the action token that brings each agent closest to its original trajectory, per Equation 6.

$${\hat{c}}_{t}^{i} = arg min d ( f ( {s}_{t}^{i} , {x}_{c} ) , {\hat{s}}_{t + 1}^{i} , c = \{ 1 , … , \vert V \vert \} \qquad Equation 6$$

Given these indices ĉₜ, the NTP policy is trained using the cross-entropy loss per Equation 7.

$${ℒ}_{θ} = - \frac{1}{N T} {\sum }_{i = 1}^{N} {\sum }_{t = 0}^{T - 1} log {π}_{θ} ( {\hat{c}}_{t}^{i} \vert {h}_{t} , M ) \qquad Equation 7$$

Since, in an embodiment, CAT-K rollout is effective only when the top-K rollouts of the policy cover the ground truth mode, a two-stage training procedure is adopted, as summarized in Algorithm 1. First, a pretrained policy is obtained through BC pretraining, then the policy is fine-tuned using CAT-K rollouts.

Algorithm 1

1: Input: Policy π_{θ}, action token vocabulary V, dataset D
2: Pre-train π_{θ} (cₜ |ĥₜ, M) with BC until convergence
3: repeat [symbol] Closed-loop supervised fine-tuning
4: Sample a traffic scenario {ŝ_{0:T}, M}
5: Init rollout state s₀ = ŝ₀ [symbol] CAT-K Rollout
6: for t in [0, . . . , T - 1] do [symbol] T steps
7: for i in [1, . . . , N] do [symbol] N agents
$\begin{matrix}8 : & Get action index for rollout {\hat{c}}_{t}^{i}\end{matrix} \qquad ( Equation 3 )$
$\begin{matrix}9 : & Get next rollout state {s}_{t + 1}^{i}\end{matrix} \qquad ( Equation 5 )$
$\begin{matrix}10 : & Compute target {\hat{c}}_{t}^{i}\end{matrix} \qquad ( Equation 6 )$
11: end for
12: end for
13: Update θ by minimizing [symbol] _{θ} ({ŝ_{0:T}, {ĉ_{1:T}, M) (Equation 7)
14: until convergence

### Training Targets

The states generated from the rollout are the inputs to the policy during fine-tuning. The training target (i.e. what action the policy is trained to predict in this state) that is used may include:
1. Those actions that were generated by CAT-K and that were followed during the rollout; or
2. As described above, target actions are constructed by looking through the “vocabulary” of the transformer (which has a finite size) and picking the action as the target action that brings the policy closest to the expert demonstration. Note that this target action is not used to generate any rollout, but is just used as the training target for the policy. Both the “rollout action” and the “training target action” are selected based on proximity to the expert demonstration, but the “rollout action” is only selected from the set of K most likely predictions of the policy, whereas the “training target action” may be selected from all possible actions.

### Examples

As illustrated in FIG. 3A, the CAT-K method is configured to unroll the policy during fine-tuning in a way that visited states remain close to the ground truth. At each time step, CAT-K first takes the top-K most likely action tokens according to the policy, then chooses the one leading to the state closest to the ground truth. As a result, CAT-K rollouts follow the mode of the ground truth (e.g., turning left), while random or top-K rollouts can lead to large deviations (e.g., going straight or right). Since the policy is essentially trained to minimize the distance between the rollout states and the ground truth states, the ground truth-based supervision remains effective for CAT-K rollouts, but not for random or top-K rollouts.

FIG. 3B illustrates an exemplary CAT-K rollout over 3 steps from t=0 to t=3, based on a token vocabulary with a size of 5. For CAT-K rollout the top-K is with respect to the probabilities p of tokens predicted by the policy, as described in the embodiments above. As shown, at each timestep the candidate action that is selected from among the top-K candidate actions is the one with the closest proximity to the ground truth (GT) action at the same timestep. The rollout therefore includes the actions generated by the policy that most closely align with the ground truth at each timestep.

FIG. 4 illustrates a flowchart of a method 400 for using a policy trained to imitate expert behaviors, in accordance with an embodiment. With respect to the present embodiment, the policy has been refined per the method 100 of FIG. 1 and/or the system pipeline 200 of FIG. 2. In an embodiment, the policy is deployed (e.g. to a cloud server, datacenter, etc.) for use thereof. In an embodiment, an application may perform the method 400 to use the policy for one or more application-specific tasks.

In operation 402, a state is input to the policy trained to imitate expert behaviors. The state refers to the state of an agent. For example, the state may be a configuration, location, current behavior, etc. of the agent.

In operation 404, an action generated by the policy based on the state is obtained. The action refers to an action to be taken by the agent. The action is predicted by the policy as one that mimics an expert behavior with respect to the input state. In some examples, the action may be for the agent to change the configuration, change the location, change the current behavior, etc.

In operation 406, the action is caused to be performed. In an embodiment, performing the action may cause the agent to perform a task. For example, the action may be performed to cause the agent to perform an autonomous driving task or a robotics task.

In an embodiment, performing the action may cause the agent to be placed in a new state. In an embodiment, the method 100 may be repeated for the new state. In this way, a sequence of actions of the agent may be controlled using the policy.

In embodiments, the policy may be trained for a single task or for a plurality of different tasks. Accordingly, in an embodiment, the method 100 may be performed (and optionally repeated) for the agent to complete the single task. In another embodiment, the method 100 may be performed and repeated for the agent to complete two or more of the plurality of different tasks.

### Exemplary Use Case—Autonomous Driving Application

In an embodiment, the method 100 may be performed by an autonomous driving application that is being used to control operations of an autonomous driving vehicle. In this exemplary embodiment, the autonomous driving application inputs a state of the autonomous driving vehicle (e.g. location, speed, environment, etc.) to the policy. The policy processes the state to generate an action for the autonomous driving vehicle (e.g. stopping, accelerating, deceleration, changing lanes, etc.). The autonomous driving application causes the autonomous driving vehicle to perform the action.

### Exemplary Use Case—Robotics Application

In an embodiment, the method 100 may be performed by a robotics application that is being used to control operations of a robot. In this exemplary embodiment, the robotics application inputs a state of the robot (e.g. configuration, location, environment, etc.) to the policy. The policy processes the state to generate an action for the robot (e.g. gripping, moving, pushing, etc.). The robotics application causes the robot to perform the action.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

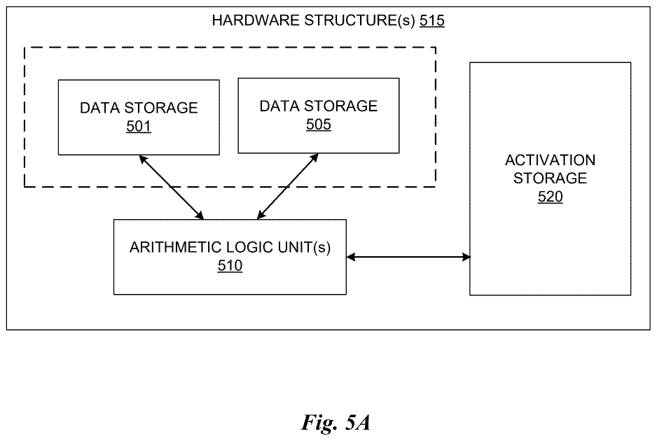

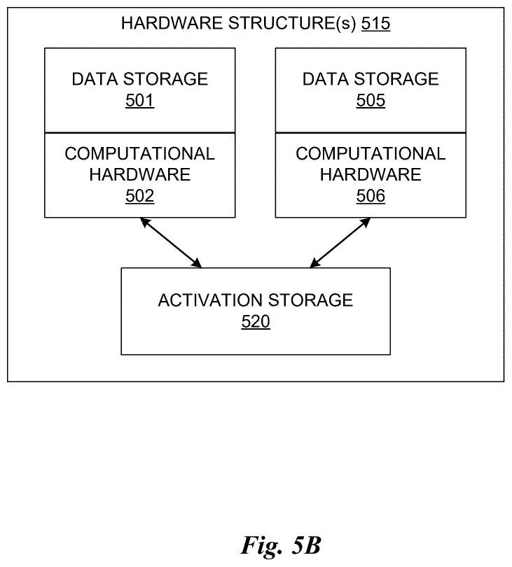

As noted above, a deep learning or neural learning system needs to be trained to generate inferences from input data. Details regarding inference and/or training logic 515 for a deep learning or neural learning system are provided below in conjunction with FIGS. 5A and/or 5B.

In at least one embodiment, inference and/or training logic 515 may include, without limitation, a data storage 501 to store forward and/or output weight and/or input/output data corresponding to neurons or layers of a neural network trained and/or used for inferencing in aspects of one or more embodiments. In at least one embodiment data storage 501 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 501 may be included with other on-chip or off-chip data storage, including a processor's L1, L2, or L3 cache or system memory.

In at least one embodiment, any portion of data storage 501 may be internal or external to one or more processors or other hardware logic devices or circuits. In at least one embodiment, data storage 501 may be cache memory, dynamic randomly addressable memory (“DRAM”), static randomly addressable memory (“SRAM”), non-volatile memory (e.g., Flash memory), or other storage. In at least one embodiment, choice of whether data storage 501 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 515 may include, without limitation, a data storage 505 to store backward and/or output weight and/or input/output data corresponding to neurons or layers of a neural network trained and/or used for inferencing in aspects of one or more embodiments. In at least one embodiment, data storage 505 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 505 may be included with other on-chip or off-chip data storage, including a processor's L1, L2, or L3 cache or system memory. In at least one embodiment, any portion of data storage 505 may be internal or external to on one or more processors or other hardware logic devices or circuits. In at least one embodiment, data storage 505 may be cache memory, DRAM, SRAM, non-volatile memory (e.g., Flash memory), or other storage. In at least one embodiment, choice of whether data storage 505 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 501 and data storage 505 may be separate storage structures. In at least one embodiment, data storage 501 and data storage 505 may be same storage structure. In at least one embodiment, data storage 501 and data storage 505 may be partially same storage structure and partially separate storage structures. In at least one embodiment, any portion of data storage 501 and data storage 505 may be included with other on-chip or off-chip data storage, including a processor's L1, L2, or L3 cache or system memory.

In at least one embodiment, inference and/or training logic 515 may include, without limitation, one or more arithmetic logic unit(s) (“ALU(s)”) 510 to perform logical and/or mathematical operations based, at least in part on, or indicated by, training and/or inference code, result of which may result in activations (e.g., output values from layers or neurons within a neural network) stored in an activation storage 520 that are functions of input/output and/or weight parameter data stored in data storage 501 and/or data storage 505. In at least one embodiment, activations stored in activation storage 520 are generated according to linear algebraic and or matrix-based mathematics performed by ALU(s) 510 in response to performing instructions or other code, wherein weight values stored in data storage 505 and/or data 501 are used as operands along with other values, such as bias values, gradient information, momentum values, or other parameters or hyperparameters, any or all of which may be stored in data storage 505 or data storage 501 or another storage on or off-chip. In at least one embodiment, ALU(s) 510 are included within one or more processors or other hardware logic devices or circuits, whereas in another embodiment, ALU(s) 510 may be external to a processor or other hardware logic device or circuit that uses them (e.g., a co-processor). In at least one embodiment, ALUs 510 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 501, data storage 505, and activation storage 520 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 520 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 520 may be cache memory, DRAM, SRAM, non-volatile memory (e.g., Flash memory), or other storage. In at least one embodiment, activation storage 520 may be completely or partially within or external to one or more processors or other logical circuits. In at least one embodiment, choice of whether activation storage 520 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 515 illustrated in FIG. 5A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5A may be used in conjunction with central processing unit (“CPU”) hardware, graphics processing unit (“GPU”) hardware or other hardware, such as field programmable gate arrays (“FPGAs”).

FIG. 5B illustrates inference and/or training logic 515, according to at least one embodiment. In at least one embodiment, inference and/or training logic 515 may include, without limitation, hardware logic in which computational resources are dedicated or otherwise exclusively used in conjunction with weight values or other information corresponding to one or more layers of neurons within a neural network. In at least one embodiment, inference and/or training logic 515 illustrated in FIG. 5B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5B may be used in conjunction with central processing unit (CPU) hardware, graphics processing unit (GPU) hardware or other hardware, such as field programmable gate arrays (FPGAs). In at least one embodiment, inference and/or training logic 515 includes, without limitation, data storage 501 and data storage 505, which may be used to store weight values and/or other information, including bias values, gradient information, momentum values, and/or other parameter or hyperparameter information. In at least one embodiment illustrated in FIG. 5B, each of data storage 501 and data storage 505 is associated with a dedicated computational resource, such as computational hardware 502 and computational hardware 506, respectively. In at least one embodiment, each of computational hardware 506 comprises one or more ALUs that perform mathematical functions, such as linear algebraic functions, only on information stored in data storage 501 and data storage 505, respectively, result of which is stored in activation storage 520.

In at least one embodiment, each of data storage 501 and 505 and corresponding computational hardware 502 and 506, respectively, correspond to different layers of a neural network, such that resulting activation from one “storage/computational pair 501/502” of data storage 501 and computational hardware 502 is provided as an input to next “storage/computational pair 505/506” of data storage 505 and computational hardware 506, in order to mirror conceptual organization of a neural network. In at least one embodiment, each of storage/computational pairs 501/502 and 505/506 may correspond to more than one neural network layer. In at least one embodiment, additional storage/computation pairs (not shown) subsequent to or in parallel with storage computation pairs 501/502 and 505/506 may be included in inference and/or training logic 515.

### Neural Network Training and Deployment

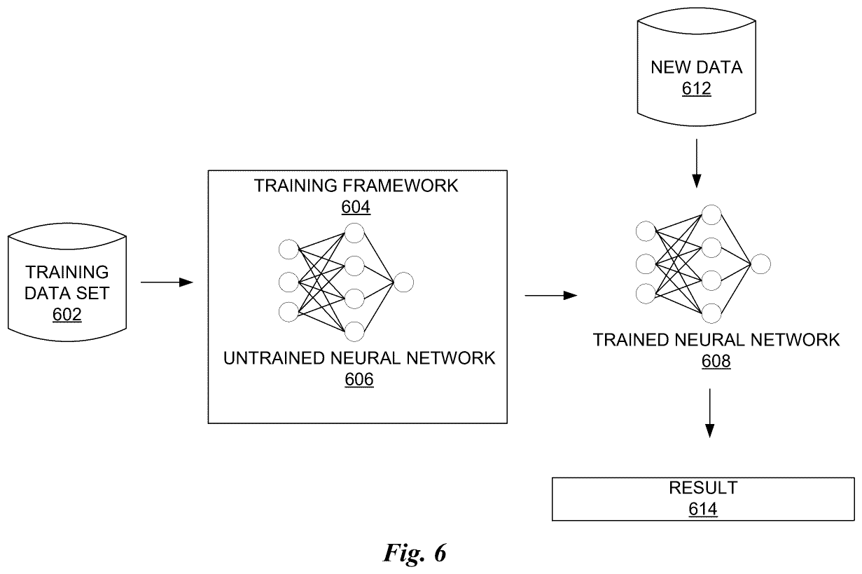

FIG. 6 illustrates another embodiment for training and deployment of a deep neural network. In at least one embodiment, untrained neural network 606 is trained using a training dataset 602. In at least one embodiment, training framework 604 is a PyTorch framework, whereas in other embodiments, training framework 604 is a Tensorflow, Boost, Caffe, Microsoft Cognitive Toolkit/CNTK, MXNet, Chainer, Keras, Deeplearning4j, or other training framework. In at least one embodiment training framework 604 trains an untrained neural network 606 and enables it to be trained using processing resources described herein to generate a trained neural network 608. In at least one embodiment, weights may be chosen randomly or by pre-training using a deep belief network. In at least one embodiment, training may be performed in either a supervised, partially supervised, or unsupervised manner.

In at least one embodiment, untrained neural network 606 is trained using supervised learning, wherein training dataset 602 includes an input paired with a desired output for an input, or where training dataset 602 includes input having known output and the output of the neural network is manually graded. In at least one embodiment, untrained neural network 606 is trained in a supervised manner processes inputs from training dataset 602 and compares resulting outputs against a set of expected or desired outputs. In at least one embodiment, errors are then propagated back through untrained neural network 606. In at least one embodiment, training framework 604 adjusts weights that control untrained neural network 606. In at least one embodiment, training framework 604 includes tools to monitor how well untrained neural network 606 is converging towards a model, such as trained neural network 608, suitable to generating correct answers, such as in result 614, based on known input data, such as new data 612. In at least one embodiment, training framework 604 trains untrained neural network 606 repeatedly while adjust weights to refine an output of untrained neural network 606 using a loss function and adjustment algorithm, such as stochastic gradient descent. In at least one embodiment, training framework 604 trains untrained neural network 606 until untrained neural network 606 achieves a desired accuracy. In at least one embodiment, trained neural network 608 can then be deployed to implement any number of machine learning operations.

In at least one embodiment, untrained neural network 606 is trained using unsupervised learning, wherein untrained neural network 606 attempts to train itself using unlabeled data. In at least one embodiment, unsupervised learning training dataset 602 will include input data without any associated output data or “ground truth” data. In at least one embodiment, untrained neural network 606 can learn groupings within training dataset 602 and can determine how individual inputs are related to untrained dataset 602. In at least one embodiment, unsupervised training can be used to generate a self-organizing map, which is a type of trained neural network 608 capable of performing operations useful in reducing dimensionality of new data 612. In at least one embodiment, unsupervised training can also be used to perform anomaly detection, which allows identification of data points in a new dataset 612 that deviate from normal patterns of new dataset 612.

In at least one embodiment, semi-supervised learning may be used, which is a technique in which in training dataset 602 includes a mix of labeled and unlabeled data. In at least one embodiment, training framework 604 may be used to perform incremental learning, such as through transferred learning techniques. In at least one embodiment, incremental learning enables trained neural network 608 to adapt to new data 612 without forgetting knowledge instilled within network during initial training.

### Data Center

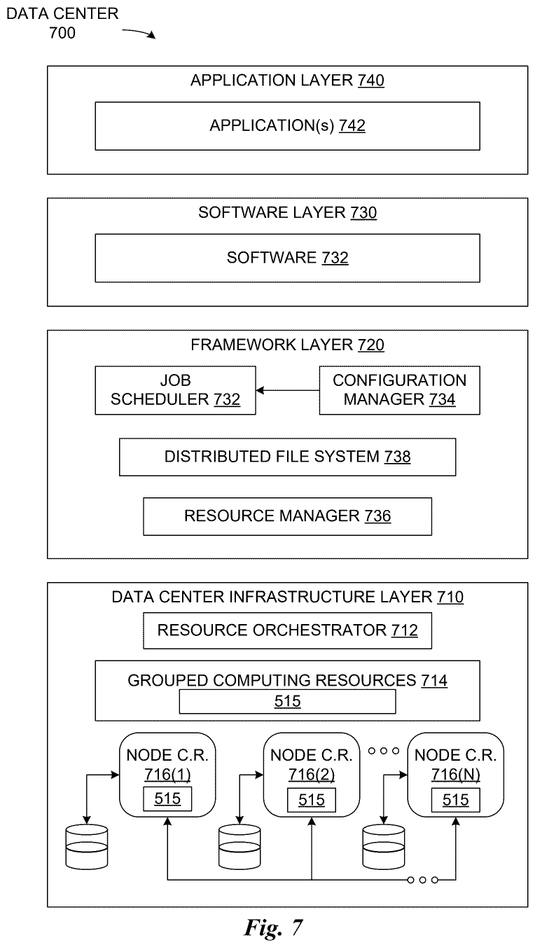

FIG. 7 illustrates an example data center 700, in which at least one embodiment may be used. In at least one embodiment, data center 700 includes a data center infrastructure layer 710, a framework layer 720, a software layer 730 and an application layer 740.

In at least one embodiment, as shown in FIG. 7, data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 716(1)-716(N) may be a server having one or more of above-mentioned computing resources.

In at least one embodiment, grouped computing resources 714 may include separate groupings of node C.R.s housed within one or more racks (not shown), or many racks housed in data centers at various geographical locations (also not shown). Separate groupings of node C.R.s within grouped computing resources 714 may include grouped compute, network, memory or storage resources that may be configured or allocated to support one or more workloads. In at least one embodiment, several node C.R.s including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 722 may configure or otherwise control one or more node C.R.s 716(1)-716(N) and/or grouped computing resources 714. In at least one embodiment, resource orchestrator 722 may include a software design infrastructure (“SDI”) management entity for data center 700. In at least one embodiment, resource orchestrator may include hardware, software or some combination thereof.

In at least one embodiment, as shown in FIG. 7, framework layer 720 includes a job scheduler 732, a configuration manager 734, a resource manager 736 and a distributed file system 738. In at least one embodiment, framework layer 720 may include a framework to support software 732 of software layer 730 and/or one or more application(s) 742 of application layer 740. In at least one embodiment, software 732 or application(s) 742 may respectively include web-based service software or applications, such as those provided by Amazon Web Services, Google Cloud and Microsoft Azure. In at least one embodiment, framework layer 720 may be, but is not limited to, a type of free and open-source software web application framework such as Apache Spark™ (hereinafter “Spark”) that may utilize distributed file system 738 for large-scale data processing (e.g., “big data”). In at least one embodiment, job scheduler 732 may include a Spark driver to facilitate scheduling of workloads supported by various layers of data center 700. In at least one embodiment, configuration manager 734 may be capable of configuring different layers such as software layer 730 and framework layer 720 including Spark and distributed file system 738 for supporting large-scale data processing. In at least one embodiment, resource manager 736 may be capable of managing clustered or grouped computing resources mapped to or allocated for support of distributed file system 738 and job scheduler 732. In at least one embodiment, clustered or grouped computing resources may include grouped computing resource 714 at data center infrastructure layer 710. In at least one embodiment, resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. one or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. In at least one embodiment, self-modifying actions may relieve a data center operator of data center 700 from making possibly bad configuration decisions and possibly avoiding underutilized and/or poor performing portions of a data center.

In at least one embodiment, data center 700 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 700. In at least one embodiment, trained machine learning models corresponding to one or more neural networks may be used to infer or predict information using resources described above with respect to data center 700 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 515 are used to perform inferencing and/or training operations associated with one or more embodiments. In at least one embodiment, inference and/or training logic 515 may be used in system FIG. 7 for inferencing or predicting operations based, at least in part, on weight parameters calculated using neural network training operations, neural network functions and/or architectures, or neural network use cases described herein.

As described herein, a method, computer readable medium, and system are disclosed to refine a policy that imitates expert behavior. In accordance with FIGS. 1-4, embodiments may provide a policy usable for performing inferencing operations and for providing inferenced data. The policy may be stored (partially or wholly) in one or both of data storage 501 and 505 in inference and/or training logic 515 as depicted in FIGS. 5A and 5B. Training and deployment of the policy may be performed as depicted in FIG. 6 and described herein. Distribution of the policy may be performed using one or more servers in a data center 700 as depicted in FIG. 7 and described herein.

What is claimed is:

1. A method, comprising:
at a device:
accessing an expert demonstration of an autonomous vehicle navigating an environment;
accessing a pretrained autonomous driving policy;
rolling out a plurality of steps of the pretrained autonomous driving policy to generate a sequence of alternating autonomous driving states and autonomous driving actions, including at each step of the plurality of steps:
processing a current autonomous driving state by the pretrained autonomous driving policy to generate a plurality of candidate autonomous driving actions,
selecting a target autonomous driving action from the plurality of candidate autonomous driving actions that results in a next autonomous driving state that most closely aligns with the expert demonstration;
fine-tuning the autonomous driving policy using on the sequence of alternating autonomous driving states and autonomous driving actions; and
causing a real-world autonomous vehicle to operate in accordance with the fine-tuned autonomous driving policy.

2. The method of claim 1, wherein the plurality of candidate autonomous driving actions include a predefined number of most probable autonomous driving actions for the current autonomous driving state.

3. The method of claim 1, wherein selecting the target autonomous driving action from the plurality of candidate autonomous driving actions that results in the next autonomous driving state that most closely aligns with the expert demonstration includes:
for each candidate autonomous driving action of the plurality of candidate autonomous driving actions, computing a distance of a next autonomous driving state observed at a next timestep as a result of the candidate autonomous driving action to a state of the expert demonstration at the next timestep, and
selecting as the target autonomous driving action, from the plurality of candidate autonomous driving actions, one of the candidate autonomous driving actions with the least distance to the state of the expert demonstration at the next timestep.

4. The method of claim 1, wherein the plurality of candidate autonomous driving actions are generated using a tokenized transformer.

5. The method of claim 1, wherein the rolling out is performed by a simulator.

6. The method of claim 1, wherein the rolling out is initiated at an initial state of the expert demonstration.

7. The method of claim 1, wherein refining the autonomous driving policy includes training the autonomous driving policy based on a training target.

8. The method of claim 7, wherein the training target is to replicate the sequence of alternating autonomous driving states and autonomous driving actions.

9. The method of claim 7, wherein the training target is proximity to the expert demonstration.

10. The method of claim 1, wherein the rolling out and the refining is repeated for each of a plurality of expert demonstrations.

11. A method, comprising:
at a device:
rolling out a plurality of steps of a policy for an autonomous agent to generate a sequence of alternating states and actions, including at each step of the plurality of steps:
processing a current state by the policy to generate a plurality of candidate actions,
selecting a target action from the plurality of candidate actions that results in a next state that most closely aligns with an expert demonstration; and
refining the policy based on the sequence of alternating states and actions.

12. The method of claim 11, wherein the policy is pretrained.

13. The method of claim 11, wherein the plurality of candidate actions include a predefined number of most probable actions for the current state.

14. The method of claim 11, wherein selecting the target action from the plurality of candidate actions that results in the next state that most closely aligns with the expert demonstration includes:
for each candidate action of the plurality of candidate actions, computing a distance of a next state observed at a next timestep as a result of the candidate action to a state of the expert demonstration at the next timestep, and
selecting as the target action, from the plurality of candidate actions, one of the candidate actions with the least distance to the state of the expert demonstration at the next timestep.

15. The method of claim 11, wherein the plurality of candidate actions are generated using a tokenized transformer.

16. The method of claim 11, wherein the rolling out is performed by a simulator.

17. The method of claim 11, wherein the rolling out is initiated at an initial state of the expert demonstration.

18. The method of claim 11, wherein refining the policy includes training the policy based on a training target.

19. The method of claim 18, wherein the training target is to replicate the sequence of alternating states and actions.

20. The method of claim 18, wherein the training target is proximity to the expert demonstration.

21. The method of claim 11, wherein the rolling out and the refining is repeated for each of a plurality of expert demonstrations.

22. The method of claim 11, further comprising, at the device:
deploying the refined policy.

23. The method of claim 22, wherein the refined policy is executed to control operation of an autonomous agent.

24. The method of claim 23, wherein the autonomous agent is an autonomous vehicle.

25. The method of claim 23, wherein the autonomous agent is an autonomous robot.

26. A system, comprising:
a non-transitory memory storage comprising instructions; and
one or more processors in communication with the memory, wherein the one or more processors execute the instructions to:
roll out a plurality of steps of a policy for an autonomous agent to generate a sequence of alternating states and actions, including at each step of the plurality of steps:
processing a current state by the policy to generate a plurality of candidate actions,
selecting a target action from the plurality of candidate actions that results in a next state that most closely aligns with an expert demonstration; and
refine the policy based on the sequence of alternating states and actions.

27. The system of claim 26, wherein the one or more processors further execute the instructions to:
deploy the refined policy for execution to control operation of an autonomous agent.

28. The system of claim 27, wherein the autonomous agent is an autonomous vehicle.

29. The system of claim 27, wherein the autonomous agent is an autonomous robot.

30. A non-transitory computer-readable media storing computer instructions which when executed by one or more processors of a device cause the device to:
roll out a plurality of steps of a policy for an autonomous agent to generate a sequence of alternating states and actions, including at each step of the plurality of steps:
processing a current state by the policy to generate a plurality of candidate actions,
selecting a target action from the plurality of candidate actions that results in a next state that most closely aligns with an expert demonstration; and
refine the policy based on the sequence of alternating states and actions.

31. The non-transitory computer-readable media of claim 30, wherein the one or more processors further execute the instructions to:
deploy the refined policy for execution to control operation of an autonomous agent.

32. The non-transitory computer-readable media of claim 31, wherein the autonomous agent is an autonomous vehicle.

33. The non-transitory computer-readable media of claim 31, wherein the autonomous agent is an autonomous robot.
